(19) United States
(12) Patent Application Publication
(10) Pub. No.: US 2020/0171770 A1
(43) Pub. Date: Jun. 4, 2020

(54) AUTOMATED PALLET PRESS

(71) Applicant: RIGHT VALUE DRUG STORES, LLC, Irving, TX (US)

(72) Inventor: Richard E. Appling, II, Denton, TX (US)

(21) Appl. No.: 16/666,720

(22) Filed: Oct. 29, 2019

Related U.S. Application Data
(60) Provisional application No. 62/775,242, filed on Dec. 4, 2018.

(51) Int. Cl. B30B 11/22; B30B 11/00

(52) U.S. Cl. CPC B30B 11/228; B30B 11/221; B30B 11/005

(57) ABSTRACT

Various embodiments for an automated pellet press for automatically producing pharmaceutical pellets are disclosed herein.

### CROSS REFERENCE TO RELATED APPLICATIONS

This is a non-provisional application that claims benefit to U.S. provisional application Ser. No. 62/775,242 filed on Dec. 4, 2018, which is herein incorporated by reference in its entirety.

### FIELD

The present disclosure generally relates systems and methods for producing pellets; and in particular to an automated pellet press having a die and plunger arrangement for automatically producing pellets.

### BACKGROUND

The manufacturing of implantable pellets, such as pellets containing testosterone, require high manufacturing standards to ensure compliance with requirements related to proper pellet shape, pellet surface area, pellet volume, and pellet integrity. In the past, manual pellet presses have been used to manufacture pellets, which can be time consuming and potentially introduce variance in pellet shape, surface, area, volume and integrity during manufacturing. As such, automated methods for manufacturing pellets that meet the stringent standards of manufacturing such implantable pellets are desirable.

It is with these observations in mind, among others, that various aspects of the present disclosure were conceived and developed.

### BRIEF DESCRIPTION OF THE DRAWINGS

FIG. 1 is a perspective view of an automated pellet press.

FIG. 2 is an exploded view of the automated pellet press of FIG. 1.

FIG. 3 is a front view of the automated pellet press of FIG. 1.

FIG. 4 shows various illustrations of upper and lower punches having different sizes and related dies that may be used with the automated pellet press of FIG. 1.

FIGS. 5A and 5B show before-and-after assembly of upper and lower punches using a simplified front view of the automated pellet press of FIG. 1.

FIGS. 6A and 6B illustrate before-and-after assembly of a face plate and vacuum tubing using a simplified enlarged front view of the automated pellet press of FIG. 1.

FIGS. 7A and 7B illustrate before-and-after assembly of a feed cup and shaker lever in relation to a die using a simplified view of the automated pellet press of FIG. 1.

FIG. 8 illustrates an assembly of the feed cup and shaker lever shown in FIG. 7B in relation to an upper punch of the automated pellet press of FIG. 1.

FIG. 9A illustrates the feed cup and shaker lever situated in alignment when the die is in a “dispensing” position with the die being shown in phantom;

FIG. 9B illustrates the feed cup and shaker lever with an elongated edge of the feed cup being out of alignment when the die is in a “non-dispensing” position;

FIG. 9C illustrates the feed cup and shaker lever with an elongated edge of the feed cup being returned to a “dispensing” position and moving across the die, an operation which facilitates the “eject” function of the automated pellet press of FIG. 1.

FIG. 10 shows an illustration of the lifting cam of the automated pellet press of FIG. 1 defining an eccentric pathway formed along its face.

Corresponding reference characters indicate corresponding elements among the view of the drawings. The headings used in the figures do not limit the scope of the claims.

### DETAILED DESCRIPTION

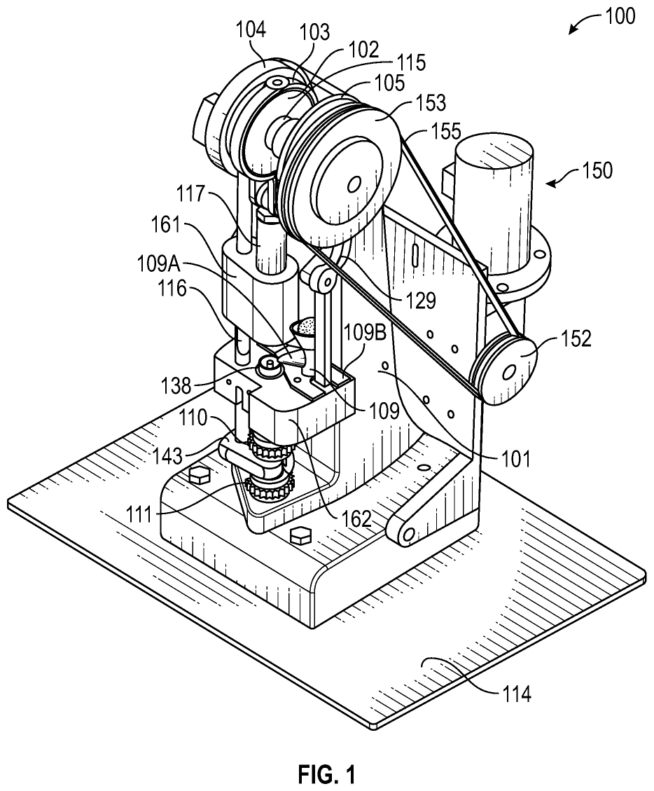

Various embodiments of an automated pellet press are disclosed herein. In some embodiments, the automated pellet press includes a frame operatively connected to a motor having a pulley arrangement that actuates an upper plunger and a lower plunger in alternating opposite axial directions such that an upper punch and a lower punch associated with the upper and lower plungers, respectively, alternately engage a die containing a pharmaceutical compound in powder form to produce an implantable pellet. In some embodiments, the pellets produced by the automated pellet press have the same size, configuration, volume, and pellet integrity to be inserted subcutaneously within a patient for delayed release or release of the pharmaceutical substance over time. Referring to the drawings, an embodiment of the automated pellet press is illustrated and generally indicated as 100 in FIGS. 1-10.

Referring to FIGS. 1-5, in some embodiments the automated pellet press 100 is operable to manufacture a plurality of pellets made from a pharmaceutical substance in an automated pressing operation. In one method of manufacture using the automated pellet press 100 a pharmaceutical substance in powder form is poured into a die 138 and then compressed into pellet form when stamped by an upper punch 140 disposed partially within an upper plunger 117 and a lower punch 141 partially disposed within a lower plunger 118 in which the upper and lower punches 140 and 141 are driven against the die 138 in alternating sequence from opposite axial directions. Once stamped, the formed pellet is then extracted from the die 138 for collection.

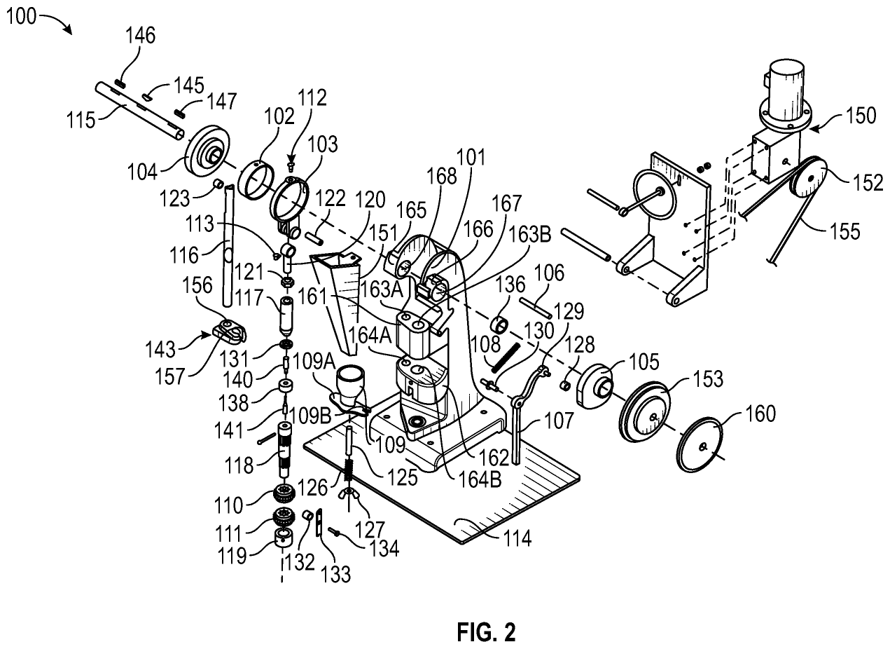

Referring to FIG. 2, the automated pellet press 100 includes a frame 101 that provides a structure for assembling the components of the automated pellet press 100. In some embodiments, the frame 101 defines an upper mounting portion 161 forming a pair of axially extending channels 163A and 163B as well as a lower mounting portion 162 forming a pair of axially extending channels 164A and 164B in respective alignment with the axially extending channels 163A and 163B. As shown, first and second shoulders 165 and 166 are defined above the upper mounting portion 161 and form aligned respective first and second longitudinal channels 167 and 168 configured to receive a rotatable main shaft 115. In some embodiments, the frame 101 may be secured or rest on a base plate 114 and/or reside within an enclosure (not shown) that prevents contaminants from contacting the pellet during manufacture.

As shown in FIGS. 1-2, a motor 150 is operably coupled to a first pulley 152 which drives a belt 155 engaged between the first pulley 152 and a second pulley 153. The second pulley 153 is coupled to a rotatable main shaft 115 mounted along the first shoulder 165 and a second shoulder 166 of frame 101. In some embodiments, a hand wheel 160 is coupled to one of the end portions of the main shaft 115 and is operable to manually operate the automated pellet press 100 by manually rotating the rotatable main shaft 115 when manual operation is desired.

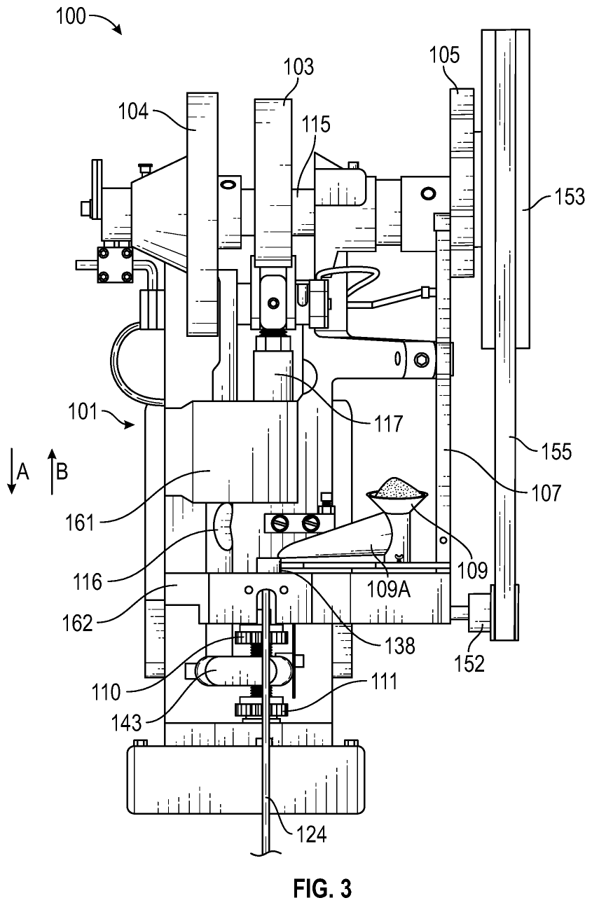

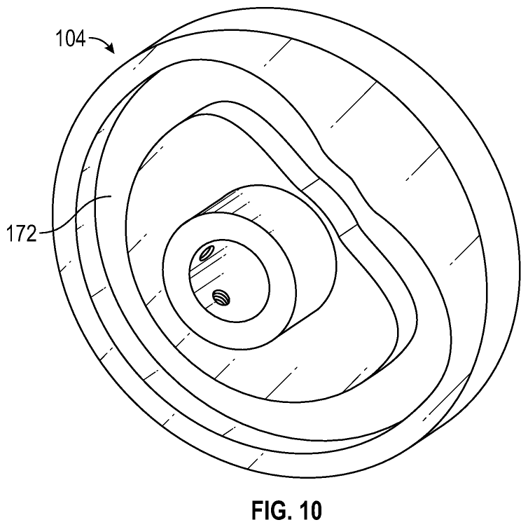

In some embodiments, the rotatable main shaft 115 is coupled to a lifting rod 116 by a converter mechanism which converts a rotational motion provided by the main shaft 115 to an up-and-down reciprocating linear motion of the lifting rod 116. One such embodiment of the converter mechanism is a lifting cam 104 defining an eccentric pathway 172 (shown in FIG. 10) which is operatively coupled to the lifting rod 116 through a laterally extending protrusion 123 defined by or coupled to the lifting rod 116 that is engaged within and follows the eccentric pathway 172 as the rotatable main shaft 115 is rotated. As the laterally extending protrusion 123 follows the path of the eccentric pathway 172 as the main shaft 115 is rotated, the lifting rod 116 is caused to move up and down in opposite axial directions A and B shown in FIG. 3. In some embodiments, a lifting block 143 is attached to the bottom portion of the lifting rod 116 through an aperture 156 formed through the lifting block 143. The lifting block 143 further defines a slot portion 157 configured to engage the lower plunger 118 such that axial movement of the lifting rod 116 causes the lower plunger 118 to concurrently move in the same axial direction. In one embodiment, the lifting rod 116 is disposed through the aligned upper channel 163A and lower channel 164A of frame 101.

As further shown, the main shaft 115 is coupled to the upper plunger 117 by a second converter mechanism which converts the rotational motion provided by the main shaft 115 to a repetitive up and down linear motion of the upper plunger 117 in opposite axial directions A and B. The second converter mechanism may be embodied as an eccentric sheave 102 coupled to the main shaft 115, wherein the eccentric sheave 102 is coaxially engaged within an eccentric strap 103 coupled to an upper plunger eyebolt 120 through an eyebolt pin 122. The upper plunger eyebolt 120 is also coupled to the upper plunger 117 using an eyebolt nut 121. In one embodiment, the upper plunger 117 is disposed through the upper channel 163B defined by the frame 101. In operation, as the main shaft 115 is rotated, the eccentric sheave 102 produces an up and down axial motion that is imparted to the upper plunger 117 through the upper plunger eyebolt 122 and eccentric strap 103. As such, movement of the upper plunger 117 in an up and down axial motion along axial directions A and B is caused by rotation of the eccentric sheave 102 by the main shaft 115 is rotated, while movement of the lower plunger 118 in a similar up and down axial motion along axial directions A and B that alternates with the up and down motion of the upper plunger 117 is caused by rotation of the lifting cam 104 by the main shaft 115 as described above. The upper punch 140 is disposed within the upper plunger 117 and secured in place using an upper plunger nut 131.

In some embodiments, the lower plunger 118 is disposed through the lower channel 164B of frame 101. As shown, the lower plunger 118 is operatively coupled with a lower adjusting nut 111 which is rotated to adjust the height of the lower punch 141 relative to the lower plunger 118 and therefore control the size of the pellet (e.g., the length of the pellet). In addition, an upper adjusting nut 110 is provided to control the flushness of the lower punch 141 relative to the die 138. As shown, the combination of an adjusting nut collar 132, adjusting nut clip 133 and adjusting nut clip screw 134 engages the upper and lower adjusting nuts 110 and 111 to the lower plunger 118 for adjustment of the lower punch 141. A lower plunger bushing 119 is coupled to the bottom end of the lower plunger 118.

As shown, the main shaft 115 is also engaged to a swivel cam 105 that defines an eccentric pathway (not shown) configured to receive a shaker roller pin 128, wherein the shaker roller pin 128 is in operative engagement with a swivel lever roller arm 129 defined by the swivel lever 107. The swivel lever roller arm 129 imparts a back and forth or rocking motion to the swivel lever 107 as the swivel lever roller arm 129 travels along the eccentric pathway defined by the swivel cam 105 as the main shaft 115 rotates. In addition, the swivel lever 107 is configured to receive a spring 108 and a swivel lever fulcrum pin 130 which is attachable to the frame 101 and collectively facilitate the back and forth motion of the swivel lever 107 imparted by the swivel cam 105 as the main shaft 115 rotates. In some embodiments, a tensioner pin 106 may be provided that ensures the top of the spring 108 is maintained at the appropriate location relative to the swivel lever 107. In some embodiments, a collar 136 is disposed through the swivel cam 105 for engagement with the main shaft 115.

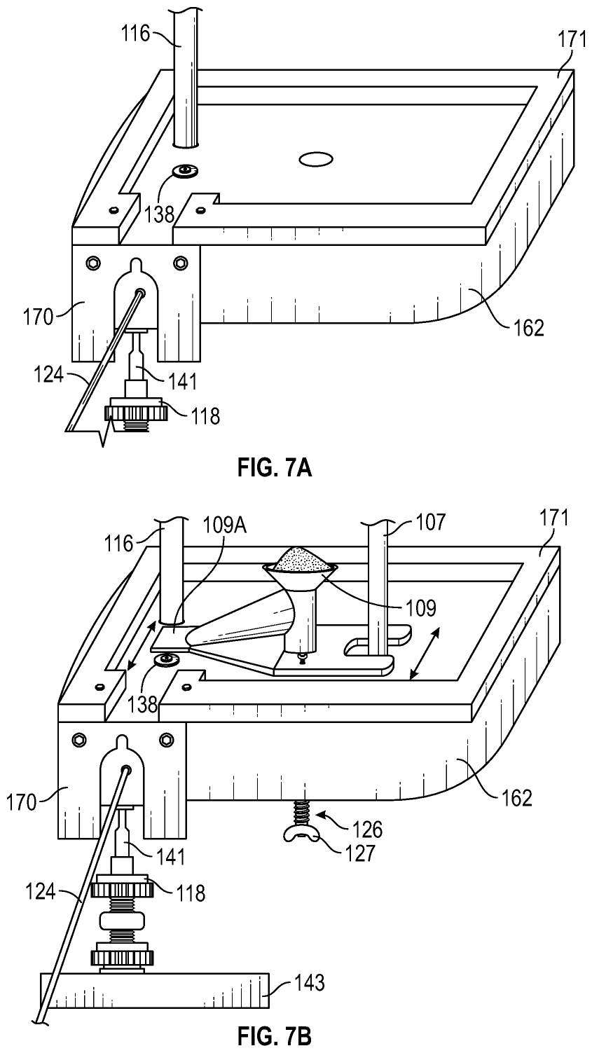

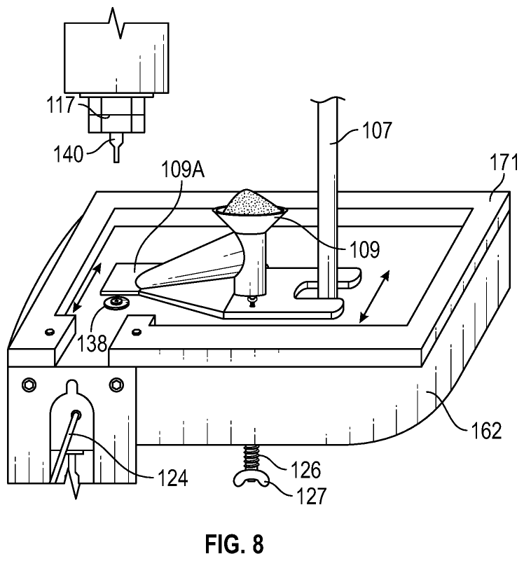

As shown in FIGS. 7A-7B and 8, the swivel lever 107 is in operative engagement with a feed cup 109 that is operable to deposit a predetermined amount of a pharmaceutical substance in powder form into the die 138 for formation of a pellet in the stamping operation. In some embodiments, the feed cup 109 may be in operative association with a hopper 151 (FIG. 2) that is configured to provide a storage conduit for supplying the pharmaceutical substance in powder form to the feed cup 109, although in other embodiments the feed cup 109 may be configured to store and dispense the pharmaceutical substance without a hopper 151. In some embodiments, the feed cup 109 may further include an elongated edge 109A positioned above the die 138 and below the upper punch 140. The feed cup 109 may also define a forked end 109B on the opposite side, wherein the forked end 109B is operable to capture the swivel lever 107, as shown in FIG. 7B. In one embodiment, the forked end 109B of the feed cup 109 couples the swivel lever 107 to the feed cup 109 such that the feed cup 109 is operable to swivel between a supply position wherein the hopper 151 supplies an amount of pharmaceutical substance into the feed cup 109 and a dispensing position wherein the feed cup 109 is aligned directly over the die 138 and dispenses an amount of pharmaceutical substance in powder form to the die 138 when shaken by the back and forth operation of the swivel lever 107 before the feed cup 109 swivels to the non-dispensing position, where the feed cup 109 is no longer positioned directly over the die 138. During this swiveling operation, the elongated edge 109A swivels across an upper side of the die 138, an operation which will facilitate the ejection of the formed pellet. This swiveling operation of the feed cup 109 between non-dispensing and dispensing positions is repeated for the formation of each individual pellet.

As noted above, the upper plunger 117 is engaged to the upper punch 140 to drive the upper punch 140 in an axial direction A and then axial direction B, while the lower plunger 118 is engaged to a lower punch 141 to drive the lower punch 141 in an opposite axial direction B and then axial direction A as illustrated in FIGS. 1-3. In this arrangement, the upper punch 140 and lower punch 141 are driven into contact with the die 138 in alternating sequence against the die 138 in an automated stamping operation as the upper plunger 117 and lower plunger 118 are actuated by operation of the motor 150 in alternating sequence relative to the die 138 as the main shaft 115 is rotated.

In some embodiments, as shown in FIG. 2 one or more oil cups 112 may be provided to supply a lubricant along the moving components of the automated pellet press 100. For example, a respective oil cup 112 may supply lubricant along the eccentric strap 103 as well as first and second channels 167 and 168 of respective first and second shoulders 165 and 166 of frame 101. In some embodiments, an oil cup 113 defining an elbow may provide a lubricant to the upper plunger eyebolt 120.

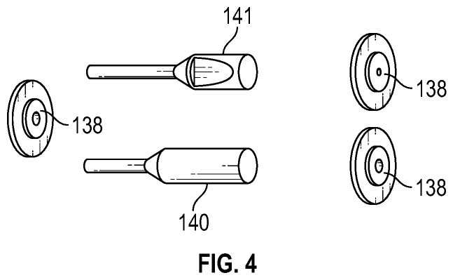

Referring to FIG. 4, embodiments of the upper and lower punches 140 and 141 and the die 138 are illustrated. In some embodiments, the upper punch 140 has a shorter length than the lower punch 141 and each may have a 3 mm or 4 mm width. Similarly, a die 138A may be configured to receive the 3 mm upper and lower punches 140/141 or a die 138B may be continued to receive the 4 mm upper and lower punches 140/141 in an alternate embodiment. In one aspect, the upper and lower punches 140/141 may have different sizes to comport with the size of the die 138 used to form the pellets of a particular shape and size during the stamping operation.

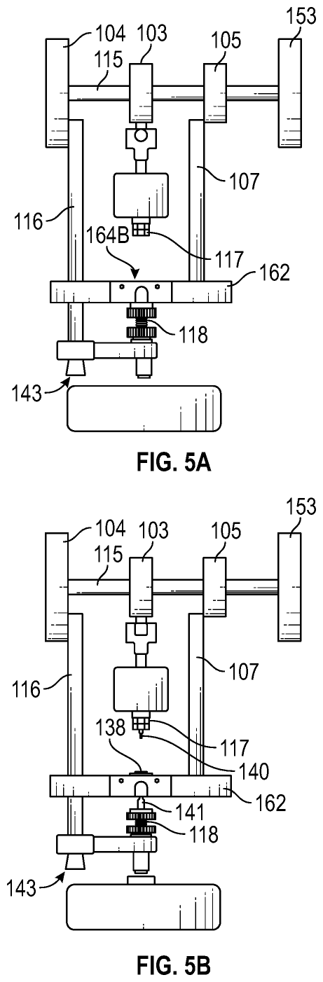

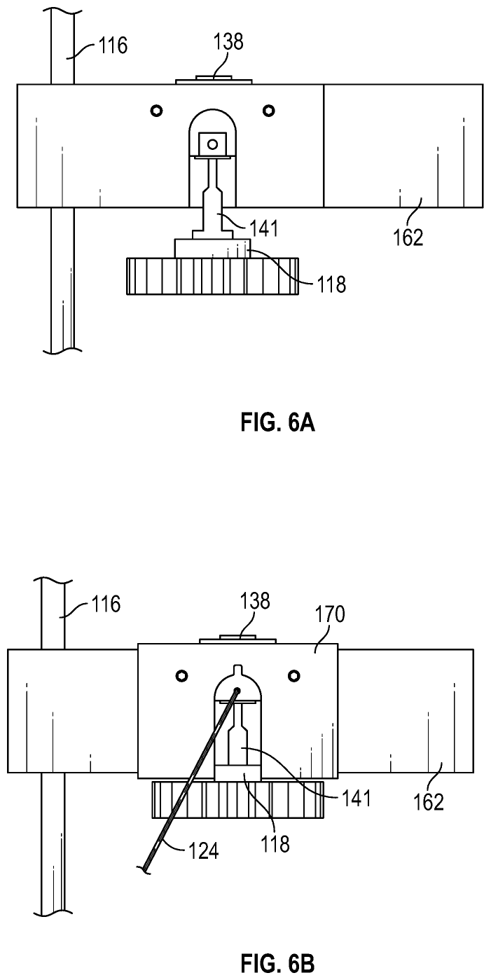

Referring to FIGS. 5A and 5B as noted above, the upper punch 140 is in operative engagement with the upper plunger 117 and the lower punch 141 is in operative engagement with the lower plunger 118. Upon assembly, the upper punch 140 is inserted into the upper plunger 117 and the lower punch 141 is inserted into the lower plunger 118. Upon assembly, the die 138 is inserted into the lower channel 164B. Referring to FIGS. 6A and 6B, in some embodiments a vacuum tubing 124 is in operative association with the die 138 such that suction is provided by the vacuum tubing 124 to facilitate the deposition of powder into the die 138. As shown in FIG. 6B, some embodiments of the lower mounting portion 162 of the frame 102 may have a face plate 170 affixed to the lower mounting portion 162 for protection. Referring to FIG. 7A, a top plate 171 is mounted onto the lower mounting portion 162 and secured to the face plate 170. Referring to FIG. 2, the feed cup 109 may be mounted to the top plate by the feed cup bolt 125, wherein the feed cup bolt 125 is sheathed by the feed cup spring 126 and secured by the feed cup nut 127. As noted above, the feed cup 109 is coupled to the swivel lever 107 by a forked end 109B of the feed cup 109 such that the feed cup 109 is operable to swivel between a dispensing position and a non-dispensing position.

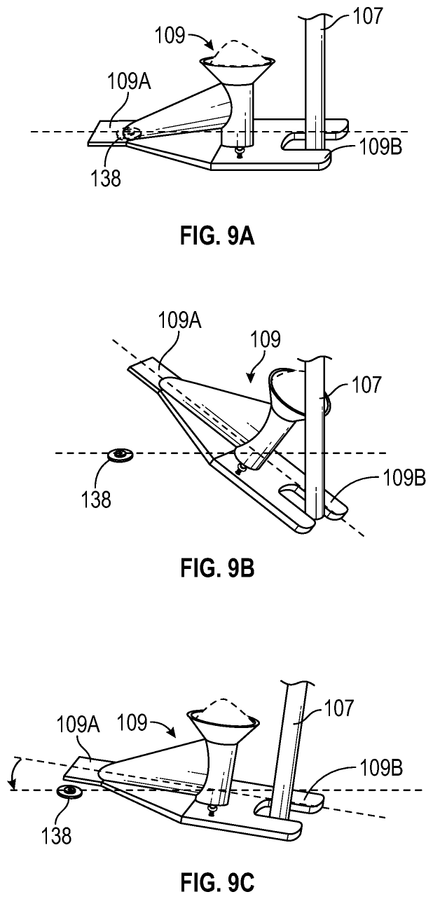

The dispensing position, as shown in FIG. 9A, involves swiveling the elongated end 109A of the feed cup 109 over the die 138 such that an amount of powdered material is dispensed into the die 138. The elongated end 109A of the feed cup 109 is then swiveled into a non-dispensing position away from the die, as shown in FIG. 9B. While the feed cup 109 is in the non-dispensing position, the upper and lower punches 140/141 contact the die 138 in alternating sequence and stamp the powdered material into a pellet. The feed cup 109 is then returned to the dispensing position, however, as shown in FIG. 9C, the lower punch 141 lifts the pellet out of the die 138 and the elongated edge 109A of the feed cup 109 contacts and expels the pellet out of the die 138 and into a repository (not shown), thus ejecting the pellet from the die 138 in time to fill the die 138 with more powdered material for forming another pellet.

One method of manufacturing pellets using the automated pellet press 100 as disclosed herein shall be discussed. As noted above, a predetermined amount of a powdered material, such as a pharmaceutical substance, is first deposited into the die 138 by feed cup 109. Once the powdered material is deposited into the die 138, the feed cup 109 swivels away from the dispensing position and the lower plunger 118 is actuated in axial direction B such that the lower punch 141 contacts the die 138 and sets the powdered material within the die 138. After the die 138 is contacted by the lower punch 141, the upper plunger 117 then drives the upper punch 140 into contact the die 138 from opposite axial direction A to fully form the pellet within the die 138 from the deposited powder material. The lower plunger 118 then subsequently drives the lower punch 141 into contact with the die 138 again from axial direction B to extract and remove the formed pellet from the die 138, lifting the formed pellet in an axial direction B out of the die. After the lower punch 141 lifts the formed pellet from the die 138, the feed cup 109 swivels back into the dispensing position again to dispense another amount of powdered substance into the die 138 for formation of another pellet by the upper and lower punches 140 and 141 in the stamping operation. During the swiveling operation of the feed cup 109 shown in FIG. 9C, the elongated edge 109A of the feed cup 109 concurrently knocks the formed pellet having been lifted by the lower punch 141 out of alignment with the die 138 for collection. As such, the three step stamping operation of the upper and lower punches 140 and 141 set, form, and extract each pellet from the die 138.

In some embodiments, as shown in FIG. 6B, vacuum tubing 124 is in communication with the die 138 to apply a vacuum or suction to the interior portion of the die 138 to facilitate the formation of the deposited powder material within the die 138 prior to the stamping operation between the upper and lower punches 140 and 141.

In some embodiments as shown in FIG. 2, the rotatable main shaft 116 defines a first key 146 for preventing slippage of the lifting cam 104 from the rotatable main shaft 115, a second key 145 for preventing slippage of the eccentric sheave 102 from the rotatable main shaft 115, and a third key 147 for preventing slippage of the swivel cam 105 from the rotatable main shaft 115.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. An automated pellet press comprising:
a motor for rotating a rotatable main shaft;
a frame in rotatable engagement with the rotatable main shaft;
a lower plunger in operative association with the rotatable main shaft for driving the lower plunger in a first axial direction as the rotatable main shaft rotates;
a lower punch secured to the lower plunger;
an upper plunger in operative association with the rotatable main shaft for driving the upper plunger in an opposite second axial direction as the rotatable main shaft rotates;
an upper punch secured to the upper plunger; and
a die disposed on the frame, the die configured to receive a powder material;
wherein the lower punch contacts a side of the die when the lower plunger is driven in the first axial direction and the upper punch contacts an opposite side of the die when the upper plunger is driven in the opposite second axial direction, wherein the upper and lower plungers are driven in alternating sequence in a stamping operation to form a pellet from the powder material.

2. The automated pellet press of claim 1, further comprising:
a feed cup configured to supply the powder material to the die, the feed cup being operable between a dispensing position wherein the feed cup is aligned with the die to provide a predetermined amount of the powder material to the die and a non-dispensing position wherein the feed cup is out of alignment with the die.

3. The automated pellet press of claim 2, further comprising:
a swivel lever in operative association with the rotatable main shaft, the swivel lever being in operative engagement with the feed cup for driving the feed cup between the dispensing position and non-dispensing position.

4. The automated pellet press of claim 1, further comprising:
a lifting rod operatively connected to the rotatable main shaft, wherein the lifting rod defines one end engaged to the rotating main shaft and an opposite end coupled to the lower plunger for driving between the lower plunger between the first axial direction and second opposite axial direction.

5. The automated pellet press of claim 4, wherein the one end of the lifting rod is operatively connected to the rotatable main shaft through a laterally extending protrusion defined by the lifting rod that follows an eccentric pathway defined by a lifting cam that is engaged to the rotatable main shaft.

6. The automated pellet press of claim 5, wherein the eccentric pathway followed by the lifting cam converts a rotational motion from the rotatable main shaft to a reciprocating linear motion for driving the lifting rod between the first axial direction and the second axial direction.

7. The automated pellet press of claim 4, wherein the opposite end of the lifting rod is coupled to a lifting block configured to engage the lower plunger for driving the lower plunger between the first axial direction and the second axial direction by the rotatable main shaft.

8. The automated pellet press of claim 1, further comprising:
an eccentric sheave connected to the rotatable main shaft, the eccentric sheave defining an eccentric pathway; and
an eccentric strap engaged to the eccentric sheave, the eccentric strap configured to follow the eccentric pathway defined by the eccentric sheave, wherein the eccentric strap is operatively associated with the upper plunger such that the upper plunger is driven between the first and second axial directions.

9. The automated pellet press of claim 8, wherein the eccentric strap is engaged to an upper plunger eyebolt for coupling the eccentric strap to the upper plunger for driving the upper plunger between the first and second axial positions.

10. The automated pellet press of claim 3, wherein the swivel lever is in operative association the rotatable main shaft through a swivel cam that defines an eccentric pathway, wherein the swivel lever defines a pin configured to follow the eccentric pathway of the swivel cam as the rotatable main shaft rotates.

11. The automated pellet press of claim 10, wherein the swivel lever defines a fulcrum pin engaged to the frame for generating a back and forth motion to the swivel lever.

12. The automated pellet press of claim 1, further comprising:
a hand wheel in operative engagement with the rotatable main shaft for manually rotating the rotatable main shaft when manually operating the automated pellet press.

13. The automated pellet press of claim 2, further comprising:
a hopper in operative communication with the feed cup for supplying an amount of the powder material to the feed cup.

14. The automated pellet press of claim 1, wherein the powder material comprises a pharmaceutical substance.

15. The automated pellet press of claim 1, wherein the lower plunger is operatively engaged with an upper and lower adjusting nuts for adjusting a position of the lower punch relative to the lower plunger.

16. The automated pellet press of claim 1, further comprising:
a vacuum tubing in operative association with the die for applying a vacuum to the powder material therein prior to contact by the upper and lower punches for causing the powder material to form within the die.

17. The automated pellet press of claim 3, wherein the swivel lever is operable for shaking the feed cup when dispensing the powder material into the die.

18. A method for pressing a powdered material into a pellet, comprising:
lifting a lower punch in a first axial direction such that the lower punch contacts a lower side of a die;
wherein the die is configured to receive a powder material;
wherein the powder material is set into the die upon contact;
wherein the lower punch is in operative association with a first converter mechanism which converts a rotational motion provided by a rotatable main shaft to a linear reciprocating motion of the lower punch;
wherein the linear reciprocating motion comprises the first axial direction and an opposite second axial direction.
lowering an upper punch in the opposite second axial direction such that the upper punch contacts a top side of the die;
wherein the powder material having been set within the die is pressed into the die upon contact by the upper punch to form a pellet;
wherein the upper punch is in operative association with a second converter mechanism which converts the rotational motion provided by a rotatable main shaft to a linear reciprocating motion of the upper punch;
wherein the linear reciprocating motion comprises the first axial direction and an opposite second axial direction;
wherein the upper punch and the lower punch are actuated in an alternating sequence to form a pellet from the powder material; and
lifting the lower punch in the first axial direction such that the lower punch contacts the lower side of a die and lifts the pellet from the die;
wherein the pellet having been lifted from the die is knocked out of alignment with the die by a feed cup having an elongated edge, wherein the feed cup having an elongated edge is operable to swivel between a dispensing position and a non-dispensing position, and wherein the elongated edge of the feed cup contacts a side of the pellet.

19. The method of claim 18, further comprising:
depositing an amount of the powder material into the die through the feed cup, wherein the feed cup is positioned directly over the die in the dispensing position;
swiveling the feed cup into the non-dispensing position such that the feed cup is no longer positioned directly over the die; and
swiveling the feed cup into the dispensing position, wherein the feed cup is configured to deposit an amount of powdered substance into the die.

20. A method for manufacturing a pellet using an automated pellet press, comprising:
providing an automated pellet press, wherein the automated pellet press comprises a die, an upper punch, and a lower punch, wherein the upper punch and lower punch are configured to be lifted in a first axial direction and lowered in an opposite second axial direction, wherein the upper punch and lower punch are operable to contact the die in an alternating sequence;
setting an amount of powdered material into a die by contacting a lower side of the die with the lower punch, wherein the lower punch is lifted in the first axial direction; and
pressing an amount of powder material having been set into a die by contacting an upper side of the die with the upper punch to form a pellet, wherein the upper punch is lowered in the opposite second axial direction;
ejecting the pellet from the die by contacting the lower side of the die with the lower punch, wherein the lower punch is lifted in the first axial direction and wherein the pellet is lifted by the lower punch and ejected from the die.
